(19) United States
(12) Patent Application Publication
(10) Pub. No.: US 2005/0027533 A1
(43) Pub. Date: Feb. 3, 2005

(54) Electronic message board

(76) Inventors: Vicki Ritchie, St. Louis Park, MN (US); Ronald V. Anderson, Golden Valley, MN (US)

Correspondence Address: Z. Peter Sawicki;WESTMAN CHAMPLIN & KELLY, Suite 1600 - International Centre, 900 South Second Avenue, Minneapolis, MN, 55402-3319, US

(21) Appl. No.: 10/632,227

(22) Filed: Jul. 31, 2003

(51) Int. Cl. G10L 21/00

(52) U.S. Cl. 704/270

(57) ABSTRACT

The present invention includes an audio message system for multiple users having a cabinet that is positioned for visual recognition by each of the multiple users. A plurality of message centers are disposed on a front face of the cabinet. Each message center is identified with an individual user. Each message center includes a visual new message indicator that is viewable by users, a switch for accessing an audio output of a new message and for deactivating the visual message indicator once the new message is heard. Each center also includes a message-input switch for inputting a new audio message and for activating the new message indicator. The message center also includes a microphone for inputting new messages and a speaker for providing audio output of messages.

### BACKGROUND OF THE INVENTION

The present invention relates to audio message centers, in particular, the present invention relates to an audio message center for multiple users.

Presently, there are numerous high-end technology message systems such as teleconference systems with the capability to store and play back messages in multiple formats including audio and video and related electronic documents. For example, U.S. published patent application 2002/0149671 describes a telephone conference system capable of storing incoming multiple medium messages for later retrieval and playback.

Another class of messages systems involves portable devices. Portable devices are described in U.S. Pat. No. 4,302,752, U.S. Pat. No. 5,999,105 and U.S. published patent application 2001/0028311. These systems are primarily for a single user and not suitable for multiple users of the same device. Such devices are designed to be pocket size for portability and there is no visual direct notification for multiple users upon receipt of a new message.

Another general category of message devices are dedicated purpose message storage devices. For example, such one device is described in U.S. Pat. No. 6,267,598 which describes a device that has the capability to play an auditory message to the handicap. U.S. Pat. No. 4,654,728 describes a device that is attachable to vehicles at automobile dealerships or at houses for sale so that information about the item for sale is placed into the device for the prospective customer.

U.S. Pat. Nos. 5,577,918 and 5,387,108 describe devices that may be linked to items such as greeting cards, picture frames, letters or medication to provide auditory messages. U.S. Pat. No. 5,903,869 describes a stick-on audio microchip recorder/playback device that non-permanently fastens on household doors, walls, and mirrors. None of these devices provide for multi-message capacity and do not involve identification of new messages for multiple users.

U.S. Pat. No. 6,167,233 describes a recording device that records and delivers multiple discrete messages for a book. Messages or information are stored on a strip used with the book and played back by touching different buttons. Each button on the device archives one message.

A non-electronic message center for delivery of discrete messages to multiple persons is described in U.S. Pat. No. 4,829,686. The message center has multiple physical compartments with doors on the front and the picture of the person to whom that box belongs. The device is used by receptionists to collect phone messages or for a car rental business to track cars. A paper message is inserted in each box, the box being identifiable with a person.

### SUMMARY OF THE INVENTION

The present invention includes an audio message system for multiple users having a cabinet that is positioned for visual recognition by each of the multiple users. A plurality of message centers are disposed on the front face of the cabinet and each message center is identified with an individual user. Each message center includes a visual new message indicator that is viewable by users to indicate existence of a new message, a switch for accessing an audio output of the new message and for deactivating the visual message indicator once the new message is heard. Each center also includes a message-input switch for inputting a new audio message and for activating the new message indicator. The message center also includes a microphone for audio input of new messages and a speaker for providing audio output of messages.

### BRIEF DESCRIPTION OF THE DRAWINGS

FIG. 1 is a block diagram view of the front face of the present invention.

FIG. 2 is a block diagram view of an audio message system of the present invention.

FIG. 3 is a schematic diagram of a switching and control circuit of the present invention.

### DETAILED DESCRIPTION OF THE PREFERRED EMBODIMENTS

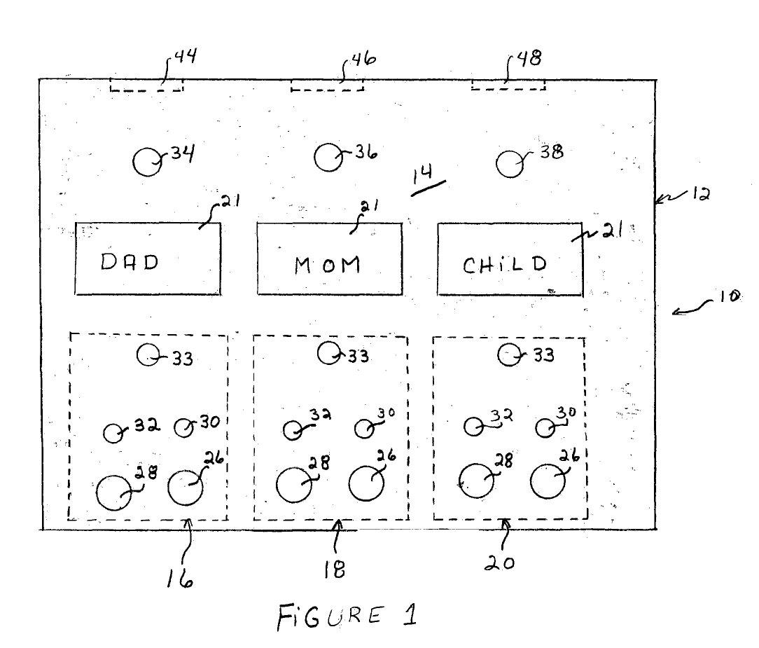

The message system of the present invention is generally indicated at 10 in FIG. 1. The message system includes a cabinet 12 having a front face 14. On the front face 14 are disposed a plurality of message centers 16, 18, and 20, each message center identifiable with a selected individual. Although three message centers are illustrated, it is understood that any number of message centers starting with two may be positioned on the front face 14 with the surface area of the front face being the limitation as to how many message centers the system includes.

The message center of the present invention is particularly useful in a residential or small office situation. In a residential home or small office, sophisticated message systems are often not practical or not affordable. In the past, non-electronic message boards on which messages were left were very useful for a residential home or a small office. For example, in a residential situation, bulletin boards have been used in the past by parents to convey to their children that they have a particular activity at a certain time on a certain day. In addition to bulletin boards, parents have left notes for their children with instructions to perform a particular task or chore. Often times such notes, since they are written on a piece of paper, are overlooked, lost or sometimes even ignored.

The present invention provides a solution wherein messages can be easily left, and that once a message is left it's existence is easily recognized by the person for whom such message has been left since the system is contained within a single cabinet that is readily viewable by all members of a household.

Positioned on the front face 14, each message center is identified with a particular individual of the household preferably by suitable indicia 21, 22 and 23 that is positioned approximate or adjacent to each message center 16, 18 and 20. The indicia may be a name, identification code or graphic such as a picture of the individual. Thereby, as each individual of the household becomes accustomed to the message system 12, and in particular each individual's message center, the particular individual will tend to pay more attention to whether their own message center has a message for them.

Since all the message centers 16, 18 and 20 illustrated in FIG. 1 are exactly the same, only one will be described with like reference characters being used to describe like individual components of all the message centers. The message center 16 (as the other message centers 18 and 20), includes a message recording switch 26, a message listening (playback) switch 28, and indicator light 30 indicating that a new message has been recorded, and indicator light 32 associated with the message listening switch 28. Preferably, the switches 26 and 28 and lights 30 and 32 are grouped in close proximity as to be viewed as a group

Preferably, the switches 26 and 28 are pushbutton switches and are color coded. For example, the message recording switch 26 is colored red while the message listening switch 28 (or playback switch) is color coded black. Similarly, the indicator light 30 which indicates a new message has been recorded is red while the indicator light 32 associated with the message listening switch 28 is green.

Each message center also includes a capacity indicator light which stays lit as long as there is sufficient memory for the audio input. When the indicator light 33 goes out, no more memory exists to accept any further audio input. Light 33 is colored differently then lights 30 and 32 such as yellow.

Associated with each message center is a microphone 34, 36 and 38, respectively. However, it is contemplated that one common microphone can be used without destroying the individuality or discreteness of each of the message centers 16, 18 and 20.

Audio speakers 44, 46 and 48 are associated respectively with each of the message centers 16, 18 and 20. Again, a common speaker for use by each of the message centers is also contemplated.

To record a message, a family member depresses the switch 26 in the message center of the individual for whom the message is intended. Depressing the switch 26 erases any existing record and records a new message. The message is inputted through microphone 33, for example, if message center 16 is being used. When the input of the message is completed, the switch 26 is released. The new message indicator light 30 stays lit after the switch 26 is released.

The person for whom the message is intended can easily see that a message has been left since the indicator light 30 is on.

To listen to a message, switch 28 is depressed. Once the switch is depressed, indicator light 32 goes on and playback of the message starts. The indicator light 32 stays on to show that the message has been heard after the message has been played back. The light 32 goes off when the swtich 26 is depressed to record a new message. The playback of the message preferably continues even if the switch is released. Each time the switch 28 is depressed, playback will start and continue until the end of the message. The message is heard through either speakers 44, 46 or 48 depending on the message center in which the recorded message is contained.

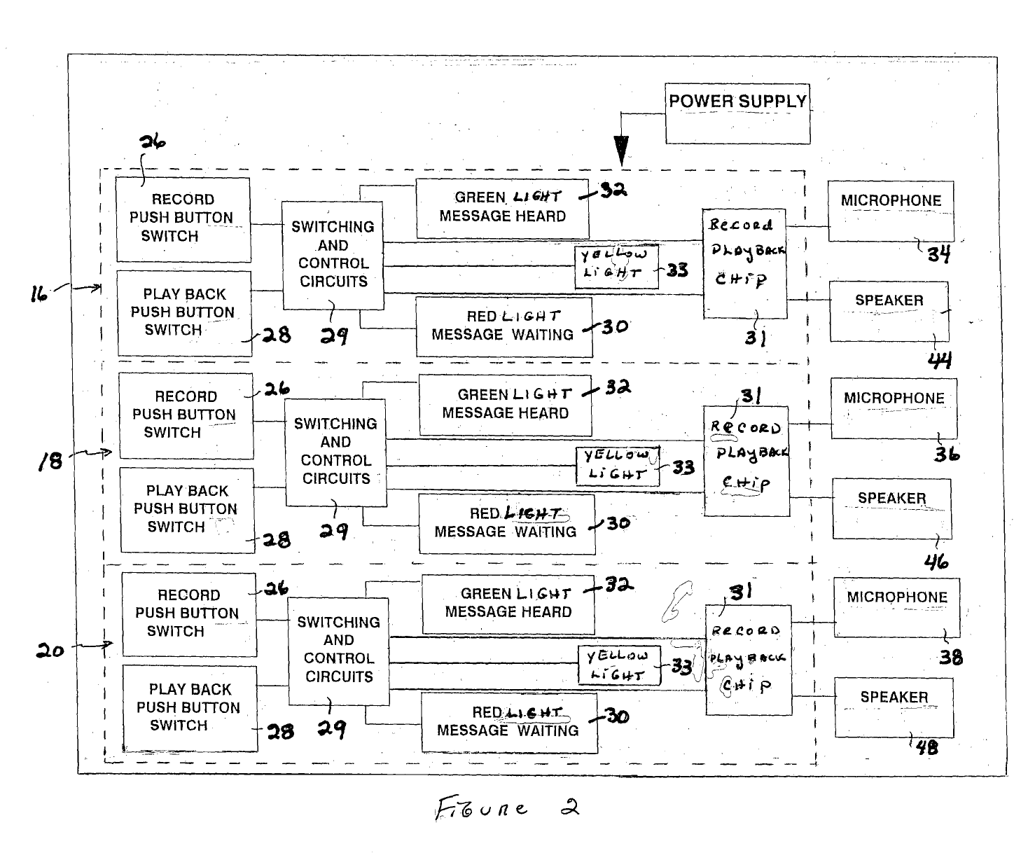

A block diagram of the audio message system of the present invention is illustrated in FIG. 2. When depressing the record pushbutton switch 26, switching and control circuits are activated which provide input and control of a record/playback chip 31 sold under the trademark of ISD by Winbond Company of San Jose, Calif. Similarly, when the playback pushbutton switch 28 is actuated, switching and control circuits 29 actuate red indicator light 32 and activate record playback chip 31 to playback a recorded message. Depending on whether the record button 26 or the playback button 28 is actuated, this either activates the microphone 34 or the speaker 44.

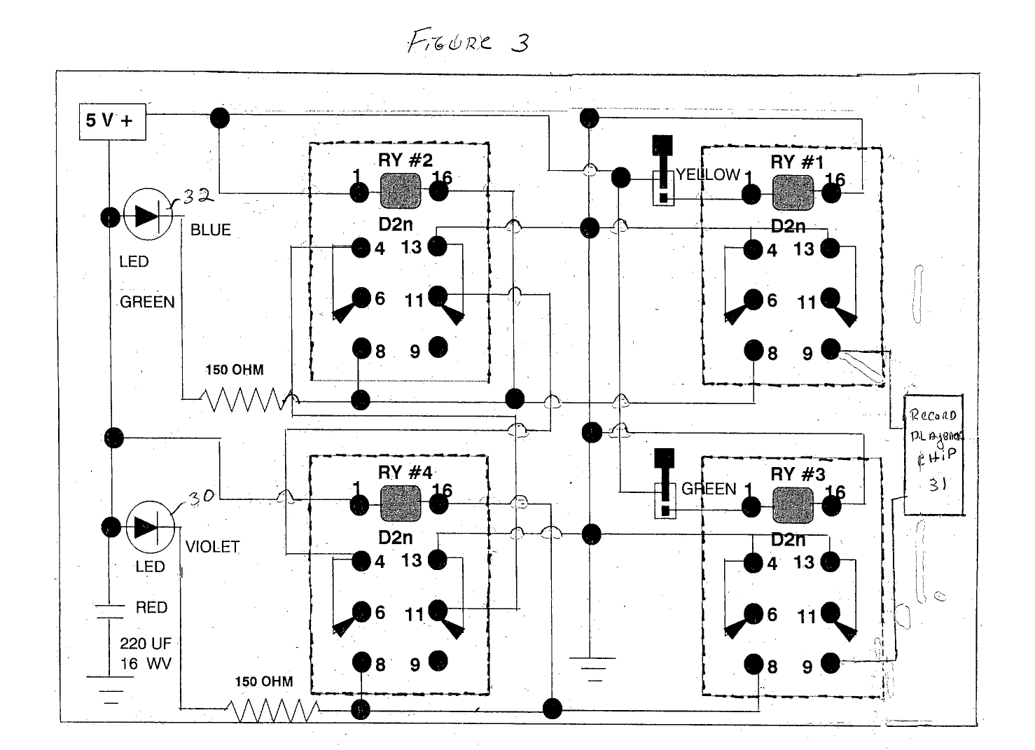

FIG. 3 is a schematic diagram of the switching and control circuits 29 of the message centers 16, 18 and 20. When the switch 26 is depressed, an existing message is erased and a new message is recorded. When the red switch 26 is depressed, relay #3 is energized which then causes pin #9 to pull a record pin of the record playback chip 31 to start recording. Also pin #8 of relay #3 energizes relay #4 and turns on light 30 (a red LED). Pin #11 of relay #4 is placed in an open position which de-energizes relay #2 and turns light 32 (a green LED) off. As the recording continues, the record playback chip 31 retains light 33 (a yellow LED) in the on position until the recording time expires.

When the switch 26 is released, relay #3 is de-energized. When relay #3 is de-energized, light 30 is held in the lit position, and relay #4 is energized through normally open contact #8 of relay #4 and normally closed contact relay #11 of relay #2. Pin #9 of relay #3 is now open and the record pin of the record playback chip is actuated to end the recording. The recording may end sooner if the memory space within the record playback chip is filled. In either situation the recording cycle is completed.

To listen to recorded messages, the black switch 28 is depressed and the green light 32 is lit and playback continues to the end of the recording. Relay #1 is energized which then causes pin #9 to pull the playback pin of the record playback chip at its low voltage position. Pin #8 of relay #1 energizes relay #2 which turns on light 32. Pin #11 of relay #2 is in the open position which de-energizes relay #4 and turns light 30 off.

When the switch 28 is released, relay #1 is de-energized. Pin #9 of relay #1 opens the playback pin of the record playback chip at high voltage which readies the record playback chip 31 for the next playback cycle. The light 30 remains lit and relay #2 is energized through normally open contact #8 of relay #2 and normally closed contact #11 of relay #4.

Although the present invention has been described with reference to preferred embodiments, workers skilled in the art will recognize that changes may be made in form and detail without departing from the spirit and scope of the invention.

1. An audio message system for multiple users, the message system comprising:
a cabinet having a front face;
a plurality of message centers disposed on the front face, each center identifiable with an individual user and visually viewable by all users of the message system, each message center comprising:
a visual new message indicator;
a new message switch for accessing an audio output of a new message and for deactivating the visual new message indicator once the new message is heard;
a message input switch for inputting new audio message and for activating the new message indicator such that the individual user identified with that message center is visually notified of a new message;
a microphone for inputting new messages; and
a speaker for providing the audio output.

2. The audio message system of claim 1 and further including indicia which associate one of the message centers with a selected individual user.

3. The message center of claim 1 wherein the visual new message indicator is a lamp positioned on the front face of the cabinet.

4. The message center of claim 1 wherein the message switch and the message input switch are pushbutton type switches disposed on the face of the cabinet.

5. The audio message system of claim 1 wherein the visual new message indicator, the new message switch and the message input switch for each message center are disposed in close proximity to each other to be viewable as a discrete group on the front face of the cabinet.

6. The system of claim 5 wherein each such group is associated with identifying indicia that relates such group to a selected individual.
